(19) United States
(12) Patent Application Publication
(10) Pub. No.: US 2010/0134494 A1
(43) Pub. Date: Jun. 3, 2010

(54) REMOTE SHADING-BASED 3D STREAMING APPARATUS AND METHOD

(75) Inventors: Choong Gyoo LIM, Daejeon (KR); Il-Kwon Jeong, Daejeon (KR); Byoung Tae Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/539,739

(22) Filed: Aug. 12, 2009

(30) Foreign Application Priority Data
Dec. 2, 2008 (KR) 10-2008-0120908
Mar. 19, 2009 (KR) 10-2009-0023570

(51) Int. Cl. G06F 13/14; G06T 15/60

(52) U.S. Cl. 345/426; 345/520

(57) ABSTRACT

A remote shading-based three-dimensional (3D) streaming apparatus includes a 3D streaming server and a 3D streaming client. The 3D streaming server includes a 3D primitive extraction unit for extracting 3D primitives from 3D scene data provided thereto; a 2D primitive conversion unit for converting the extracted 3D primitives into 2D primitives; a 2D scene and network packet construction unit for constructing 2D scene data and network packets; a network packet transmission unit for transmitting the network packets to a 3D streaming client. The 3D streaming client includes a 2D scene reconstruction unit for reconstructing 2D scene data from the network packets; a 2D primitive extraction unit for extracting 2D primitives from the 2D scene data; a 2D rasterizing unit for determining screen pixel values within a primitive region; and a display unit for providing 3D and/or virtual reality contents using the determined screen pixel value.

### CROSS-REFERENCE(S) TO RELATED APPLICATION(S)

The present invention claims priority of Korean Patent Application No. 10-2008-0120908, filed on Dec. 2, 2008, and No. 10-2009-0023570, filed on Mar. 19, 2009, which is incorporated herein by reference.

### FIELD OF THE INVENTION

The present invention relates to three-dimensional (3D) streaming technology, and, more particularly, to a remote shading-based 3D streaming system and method suitable for displaying 3D contents on mobile devices without 3D accelerators over wired or wireless networks.

### BACKGROUND OF THE INVENTION

Nowadays, with the wide popularization of 3D contents and virtual reality contents, the demand for using such contents on mobile devices has increased. As a result, a computer graphics technology has been developed so that such contents have come to be enjoyed on mobile devices equipped with 3D accelerators.

3D contents and virtual reality contents generally use a large amount of graphic data, but a mobile device has a low-capacity auxiliary memory device and a low-capacity graphic processing device so that it puts a limitation on use of 3D contents. In addition, even though a mobile device is equipped with a 3D accelerator, its popularization is limited by the problem of its increasing size and the problem of heat emission caused by a massive number of numeric operations. In order to solve these problems, a few 3D streaming technologies have been developed, which transmit 3D contents from a server to respective clients.

However, such technologies may be impossible to implement in the situation where networks are limited. Since ultra-high speed Internet are becoming increasingly common and the network bandwidth of mobile communication is also increasing, optical internets will be generalized in the near future. When this happens, 3D streaming technologies may be easily implemented.

In order to implement such 3D streaming technologies, a plurality of transmission technologies and compression technologies, specially optimized for 3D graphic data, have been developed.

There are several conventional technologies for effectively transmitting 3D graphic data. As a representative technology of those technologies, there is a technology of transmitting a minimum amount of 3D scene data and thereafter, transmitting additional data so as to improve image quality.

For example, a first technology proposes a method for identifying the minimum amount of geometric data and the minimum amount of texture data required for constructing a 3D scene, and sending the data in an initial stage. Further, in order to improve image quality of the scene, the technology evaluates the importance of texture data in the scene to ask additional data from a server.

A second technology proposes a method for identifying the initial data file and a plurality of streaming files, transmitting the files over the Internet and expressing them in real time using a 3D engine of a client.

A third technology is to transmit parts of 3D scenes and low-resolution objects while considering user's viewpoint and the network bandwidth.

A fourth technology is to transmit 3D data to the memory of a remote client and optimize a management thereof, thereby effectively transmitting 3D data. Each method may use a 3D accelerator, for example, Distributed GL, in order to maintain fixed frame rates.

A fifth technology stems from the assumption that the 3D perception of 3D objects can be acquired by providing feature lines to a certain extent. This technology proposes a method for transmitting a minimum amount of data and representing only a minimum part of scenes by extracting feature lines, such as contours, from 3D meshes, transmitting the extracted feature lines to a mobile device and representing them on it.

Of the above-described conventional 3D streaming methods, the first method has a disadvantage in that it is difficult to be implemented on a mobile device with limited storage space because, when highly descriptive data is required, the mobile device needs to be provided with lots of data from a server. Furthermore, there is another disadvantage in that a 3D accelerator is required to maintain a uniform rendering speed.

The second method has disadvantages in that a 3D accelerator is required to maintain uniform frame rates, and a large storage space is still required, as in the first method. The third method has a disadvantage in that implementing high quality images is almost impossible. The fourth method effectively uses memory space in a mobile device by using various types of information of virtual space, but it still requires no small space and needs a 3D accelerator as well.

The fifth method has disadvantages in that colors and perspective of original objects may not be sufficiently represented. Moreover, although it is a method of minimizing overhead of a mobile device, the overall overhead may not be decreased much with the server performing additional processing on 3D objects.

### SUMMARY OF THE INVENTION

In view of the above, the present invention provides a remote shading-based 3D streaming system and method for transmitting 3D scene and related data from a 3D streaming server to a streaming client and enabling the 3D scene and the related data to be represented on the streaming client, thereby providing 3D and/or virtual reality contents.

In accordance with a first aspect of the present invention, there is provided a remote shading-based three-dimensional (3D) streaming server, including:

a 3D primitive extraction unit for extracting 3D primitives from 3D scene data provided thereto;

a 2D primitive conversion unit for converting the extracted 3D primitives into 2D primitives;

a 2D scene and network packet construction unit for constructing the converted 2D primitives into 2D scene data and constructing network packets from the 2D scene data; and

a network packet transmission unit for transmitting the network packets to a 3D streaming client.

In accordance with a second aspect of the present invention, there is provided a remote shading-based 3D streaming client, including:

a 2D scene reconstruction unit for decoding network packets received from a 3D streaming server and reconstructing 2D scene data from the network packets;

a 2D primitive extraction unit for extracting 2D primitives from the 2D scene data;

a 2D rasterizing unit for determining screen pixel values within a primitive region using color values at vertex coordinates of the 2D primitives; and

a display unit for providing 3D and/or virtual reality contents using the determined screen pixel value.

In accordance with a third aspect of the present invention, there is provided a remote shading-based 3D streaming method, including:

extracting 3D primitives from 3D scene data;

converting the extracted 3D primitives into 2D primitives;

constructing the converted 2D primitives into 2D scene data; constructing network packets from the 2D scene data, for the transmission via network.

reconstructing 2D scene data using the network packets received from a 3D streaming server;

extracting 2D primitives from the reconstructed 2D scene data;

determining screen pixel values within a primitive region while considering color values at vertex coordinates of the 2D primitives; and

providing 3D and/or virtual reality contents using the determined screen pixel value.

### BRIEF DESCRIPTION OF THE DRAWINGS

The above features of the present invention will become apparent from the following description of embodiments given in conjunction with the accompanying drawings, in which:

FIG. 1 is a block diagram showing a remote shading-based 3D streaming system in accordance with an embodiment of the present invention;

FIG. 2 is a flowchart showing the detailed operation of the 3D streaming server shown in FIG. 1; and

FIG. 3 is a flowchart showing the detailed operation of the 3D streaming client shown in FIG. 1.

### DETAILED DESCRIPTION OF THE PREFERRED EMBODIMENTS

The operating principle of the present invention will be described in detail below with reference to the accompanying drawings. In the following description of the present invention, if it is determined that detailed descriptions of well-known functions or constructions may make the gist of the present invention unnecessarily unclear, the descriptions will be omitted.

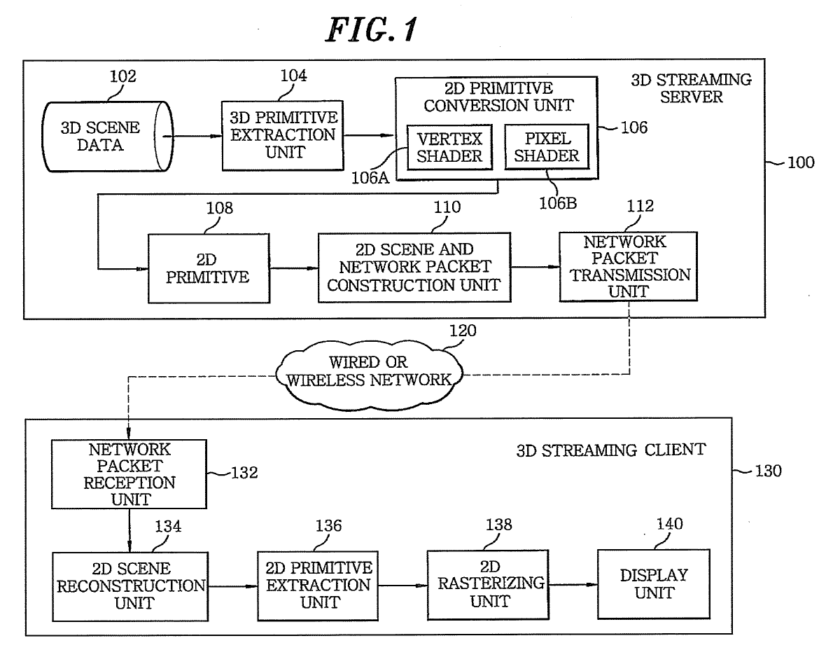

FIG. 1 is a block diagram showing a remote shading-based 3D streaming system in accordance with an embodiment of the present invention.

Referring to FIG. 1, the 3D streaming system includes a 3D streaming server 100 and a 3D streaming client 130.

The 3D streaming server 100 is adapted to implement 3D streaming technology of the present invention. The 3D streaming server 100 includes a 3D primitive extraction unit 104, a 2D primitive conversion unit 106, a 2D scene and network packet construction unit 110, and a network packet transmission unit 112.

The 3D streaming client 130 includes a network packet reception unit 132, a 2D scene reconstruction unit 134, a 2D primitive extraction unit 136, a 2D rasterizing unit 138, and a display unit 140.

In the 3D streaming server 100, the 3D primitive extraction unit 104 extracts 3D primitives from 3D scene data 102 representing a 3D and/or virtual reality contents. The extracted 3D primitives are sent to the 2D primitive conversion unit 106.

The 2D primitive conversion unit 106 converts the 3D primitives into 2D primitives 108. The 2D primitive conversion unit 106 includes a vertex shader 106A and a pixel shader 106B same as those in a typical graphics pipeline. Specifically, by performing the function of the vertex shader 106A and the pixel shader 106B, the 2D primitive conversion unit 106 converts vertex values, which are composed of 3D spatial coordinates, texture coordinates and color values, into coordinates on 2D screen, and then calculates a pixel value on the screen. Here, the vertex shader 106A dynamically performs conversion of vertices of the 3D primitives at 3D coordinates with the current setting of a camera, and the pixel shader 106B computes corresponding colors in 2D space using each coordinate formed by the vertex shader 106A.

In order to process a large number of 3D vertices, the 2D primitive conversion unit 106 needs to have a 3D accelerator. Because it is necessary to process 3D data in real time (for example, 30 or more frames per second) in the 3D streaming server 100. By performing 3D process over the network, it is possible to use 3D applications on remote devices not equipped with a 3D accelerator.

Meanwhile, prior to the conversion, the 2D primitive conversion unit 106 performs view frustum culling and back-face culling in advance. Here, the view frustum culling is a technique of determining whether a specific object exists within a view region. The back-face culling is a technique for not drawing the back side of some faces or polygons. Further, the 2D primitive conversion unit 106 may additionally perform a depth test to considerably reduce data to be transmitted to the 3D streaming client 130.

Through the above process, the 3D primitives are converted into 2D primitives 108, by the 2D primitive conversion unit 106, and the 2D primitives 108 are delivered to the 2D scene and network packet construction unit 110.

The 2D scene and network packet construction unit 110 constructs 2D scene data using the acquired 2D primitives 108, and constructs network packets transmissible through the wired or wireless network 120. Thereafter, the constructed network packets are delivered to the network packet transmission unit 112.

Meanwhile, the 2D scene and network packet construction unit 110 may be implemented in such a way that it is divided into two units, i.e., a 2D scene construction unit for constructing 2D scenes using the 2D primitives 108 and a network packet construction unit for forming the network packets using the 2D scene data.

At this time, since view frustum culling and back face culling have been performed in the 2D primitive conversion unit 106, the number of 2D primitives 108 is smaller than that of 3D primitives and the 2D primitives 108 occupy smaller memory space than 3D primitives. Moreover, when the depth test has been additionally performed in the 2D primitive conversion unit 106, the number of 2D primitives 108 becomes much smaller, and thus the amount of data, i.e. the amount of network packets, to be transmitted to the 3D streaming client 130 can be significantly reduced.

Meanwhile, an existing 3D pipeline manages a scene display in applications with initial 3D primitives, while the present invention, in order to perform scene management, constructs 2D scene data using the 2D primitives 108 converted by the 3D streaming server 100. This scene construction enables the 3D streaming client 130 to provide user interface such as selection of objects and execution of menu options, without requiring any additional assistance of the 3D streaming server 100. The network packet transmission unit 112 transmits the constructed network packets to the 3D streaming client 130 over the wired or wireless communication network 120.

In this case, an available wireless transmission method may be at least any one of a mobile communication method such as CDMA (code division multiple access) or WCDMA (wideband code division multiple access), Wibro (wireless broadband internet), Bluetooth, and a wireless LAN (Local Area Network).

The network packet reception unit 132 of the 3D streaming client 130 receives the network packets from the 3D streaming server 100 and provides the network packets to the 2D scene reconstruction unit 134. The 2D scene reconstruction unit 134 reconstructs the 2D scene data by decoding the network packets.

The 2D primitive extraction unit 136 extracts 2D primitives from the reconstructed 2D scene data, and then passes the 2D primitives to the 2D rasterizing unit 138.

The 2D rasterizing unit 138 obtains final pixel values to be displayed on a screen in a primitive region using the color values of the vertices of the 2D primitives. The obtained pixel values are provided to the display unit 140, and the display unit 140 displays the pixel values.

Such a 3D streaming client may includes a mobile device such as a cellular phone, PCS phone, smart phone and PDA, a PC, a laptop, UMPC (ultra-mobile PC), or the like which is capable of communicating with the 3D streaming server 100 over the wired or wireless network 120 and capable of performing the rasterizer function.

Meanwhile, the 3D streaming client 130 may additionally have the function of the depth test. In this case, it is possible that the 3D streaming server 100 does not perform the depth test to allow the 3D streaming client 130 to perform the depth test. Furthermore, the 3D streaming client 130 may be implemented to perform the function of the pixel shader 106B, in order to reduce the load of the 3D streaming server 100. In this case, the 3D streaming server 100 does not need to have the pixel shader 106B.

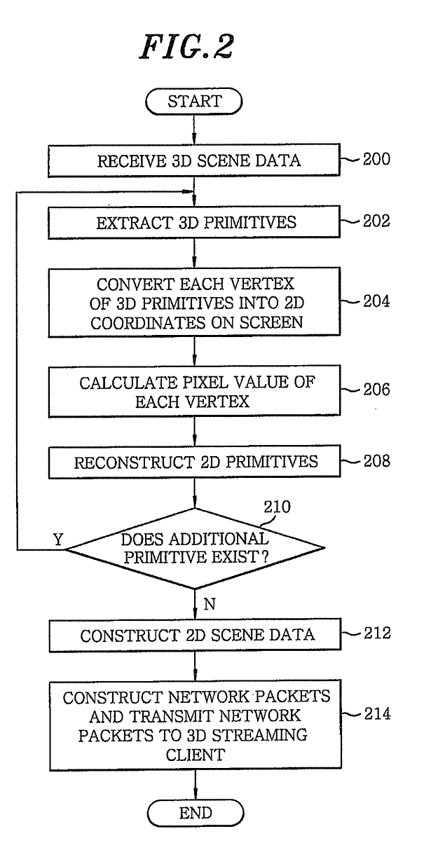

FIG. 2 is a flowchart showing the detailed operation of the 3D streaming server shown in FIG. 1.

Referring to FIG. 2, when the 3D streaming server 100 receives 3D scene data 102 at step 200, the 3D primitive extraction unit 104 extracts 3D primitives from the 3D scene data 102, i.e. 3D meshes of objects forming a 3D scene, at step 202.

The 2D primitive conversion unit 106 converts coordinates of respective vertices of the 3D primitives into 2D screen coordinates in an object space at step 204, and calculates pixel values to be displayed on a screen using light source setting information, the texture information of an object and the color values of vertices at step 206. Through the above operations, 2D primitives 108 are constructed at step 208.

Thereafter, it is determined whether an additional 3D primitive to be processed exists in the same 3D scene data at step 210. If an additional 3D primitive exists in the same 3D scene data, the process returns to step 202. If an additional 3D primitive does not exist, 2D scene data is constructed by the 2D scene and network packet construction unit 110 using the 2D primitives 108, at step 212.

Thereafter, at step 214, network packets are constructed by encoding the constructed 2D scene data, and the network packets are then transmitted to the 3D streaming client 130 over the wired or wireless communication network 120.

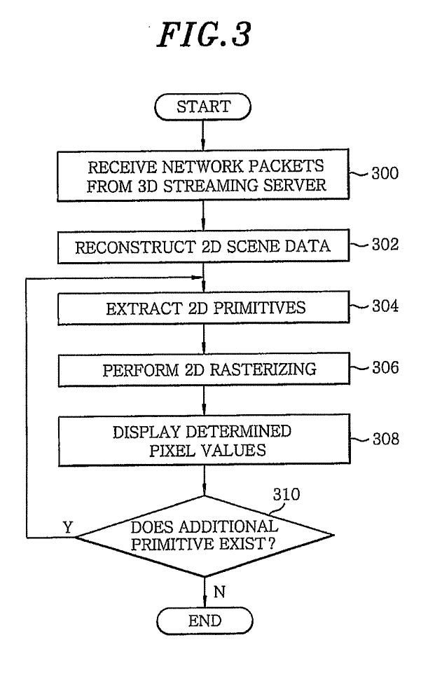

FIG. 3 is a flowchart showing the detailed operation of the 3D streaming client 130 shown in FIG. 1.

Referring to FIG. 3, the network packet reception unit 132 of the 3D streaming client 130 receives network packets for 2D scene data at step 300 and passes the network packets to the 2D scene reconstruction unit 134. The 2D scene reconstruction unit 134 decodes the network packets to reconstruct the 2D scene data at step 302.

Thereafter, the 2D primitive extraction unit 136 extracts 2D primitives from the reconstructed 2D scene data at step 304. Next, screen pixel values within a primitive region are determined by the 2D rasterizing unit 138 using the color values of the vertices of the 2D primitives at step 306. Subsequently, the determined screen pixel values are displayed through the display unit 140 at step 308.

Thereafter, it is determined whether an additional primitive to be processed exists in the same 2D scene data at step 310. If an additional primitive exists, the process returns to step 304. If an additional primitive does not exist, the presentation of a current scene being displayed is terminated.

As described above, the amount of 2D scene data constructed using 2D primitives is reduced by performing view frustum culling, back face culling and depth test on 3D primitives, that is, the amount of the 2D scene data is much smaller than the amount of 3D scene data or 2D image data composing an entire screen. Therefore, the present invention transmits remarkably small amount of data in comparison to an existing 3D scene data streaming technology or an existing 3D image streaming technology. In addition, while the existing 3D streaming technology has a limit of implementing high-quality of images since it reduces the amount of 3D data to reduce data to be transmitted, the present invention may implement the highest quality of images even on mobile devices by using the high-quality 3D images included in a server to represent colors and perspective of original data. In the present invention, since a client does not need to employ 3D accelerators, unlike the existing 3D streaming technologies, the problems of the increasing size and the increasing heat radiation of mobile devices can be overcome. Further, since 3D contents can be displayed even by a low-priced device without a 3D accelerator, supply and service of 3D and/or virtual reality contents may be expanded.

While the invention has been shown and described with respect to the embodiments, it will be understood by those skilled in the art that various changes and modifications may be made without departing from the scope of the invention as defined in the following claims.

What is claimed is:

1. A remote shading-based three-dimensional (3D) streaming server, comprising:
a 3D primitive extraction unit for extracting 3D primitives from 3D scene data provided thereto;
a 2D primitive conversion unit for converting the extracted 3D primitives into 2D primitives;
a 2D scene and network packet construction unit for constructing the converted 2D primitives into 2D scene data and constructing network packets from the 2D scene data; and
a network packet transmission unit for transmitting the network packets to a 3D streaming client.

2. The remote shading-based 3D streaming server of claim 1, wherein the 2D primitive conversion unit performs view frustum culling, back face culling, and depth test in order to determine whether to perform drawing on a view region.

3. The remote shading-based 3D streaming server of claim 1, wherein the 2D primitive conversion unit includes:
a vertex shader for converting respective vertices of the 3D primitives at 3D coordinates; and
a pixel shader for computing screen pixel values using screen coordinate values formed by the vertex shader.

4. The remote shading-based 3D streaming server of claim 3, wherein the 2D primitive conversion unit further includes a 3D accelerator for processing a number of vertices of the 3D primitives.

5. The remote shading-based 3D streaming server of claim 1, wherein the 3D primitives are converted into the 2D primitives by performing conversion only on respective vertices of the 3D primitives at 3D coordinates.

6. A remote shading-based 3D streaming client, comprising:
a 2D scene reconstruction unit for decoding network packets received from a 3D streaming server and reconstructing 2D scene data from the network packets;
a 2D primitive extraction unit for extracting 2D primitives from the 2D scene data;
a 2D rasterizing unit for determining screen pixel values within a primitive region using color values at vertex coordinates of the 2D primitives; and
a display unit for providing 3D and/or virtual reality contents using the determined screen pixel value.

7. The remote shading-based 3D streaming client of claim 6, wherein the 2D rasterizing unit performs depth test on the extracted 2D primitives.

8. The remote shading-based 3D streaming client of claim 6, wherein the 2D rasterizing unit computes the screen pixel values using screen coordinate values of the extracted 2D primitives and then performs 2D rasterizing.

9. The remote shading-based 3D streaming client of claim 6, wherein the 3D streaming apparatus further comprises a network packet reception unit for receiving the network packets encoded by the 3D streaming server over a wired or wireless communication network.

10. A remote shading-based 3D streaming method, comprising:
extracting 3D primitives from 3D scene data;
converting the extracted 3D primitives into 2D primitives;
constructing 2D scene data using the converted 2D primitives;
constructing network packets from the 2D scene data, for transmission via network.
reconstructing 2D scene data using the network packets, received from a 3D streaming server;
extracting 2D primitives from the reconstructed 2D scene data;
determining screen pixel values within a primitive region using color values of vertex coordinates of the 2D primitives; and
providing 3D and/or virtual reality contents using the determined screen pixel value.

11. The remote shading-based 3D streaming method of claim 10, wherein said converting the 3D primitives into 2D primitives includes performing view frustum culling, back face culling, and depth test in order to determine whether to perform drawing on a view region.

12. The remote shading-based 3D streaming method of claim 10, wherein said converting the 3D primitives into 2D primitives includes:
converting respective vertices of the 3D primitives at 3D coordinates; and
computing screen pixel values using screen coordinate values.

13. The remote shading-based 3D streaming method of claim 10, wherein said converting the 3D primitives into 2D primitives includes performing conversion of the 3D primitives into the 2D primitives by performing conversion only on respective vertices of the 3D primitives at 3D coordinates.

14. The remote shading-based 3D streaming method of claim 10, wherein said determining screen pixel value includes performing a depth test on the extracted 2D primitives.

15. The remote shading-based 3D streaming method of claim 10, wherein said determining screen pixel value includes computing screen pixel values using screen coordinate values of the extracted 2D primitives.

16. The remote shading-based 3D streaming method of claim 10, wherein the 3D streaming method further comprises receiving the packets encoded by the 3D streaming server over a wired or wireless communication network and decoding the received packets.

17. The remote shading-based 3D streaming method of claim 10, wherein the 3D streaming server performs vertex shading and pixel shading to generate 2D scene data and then constructs network packets from the 2D scene data.
